(19) United States
(12) Patent Application Publication
(10) Pub. No.: US 2001/0027432 A1
(43) Pub. Date: Oct. 4, 2001

(54) Method of establishing a system of a secondary market for disbursement information

(76) Inventor: Kazuhide Adachi, Hachioji-shi (JP)

Correspondence Address: GREER, BURNS & CRAIN, 300 S WACKER DR, 25TH FLOOR, CHICAGO, IL, 60606, US

(21) Appl. No.: 09/811,932

(22) Filed: Mar. 19, 2001

(30) Foreign Application Priority Data
Mar. 31, 2000 (JP) 2000-096611

(51) Int. Cl. G06F 17/60

(52) U.S. Cl. 705/37

(57) ABSTRACT

The present invention provides a method of establishing a system of a secondary market for disbursement information, wherein with “purchase plan information” of merchandise owned by a nation or others added with an asset value and utilized independently, purchase plan information is given to business firms that desire to utilize it, its cost being payable by buyers, as the information has an asset value.

Each disbursement information can be called as information of planned purchase or “Purchase Plan Information”. Said purchase plan information is quantified; its value is computed, swapped to bonds or warrants, or swapped to securities by fixing a common currency unit like yen; said information is sold, bought or brokered at a secondary market for information; said information is brokered at auction under appropriate conditions of the auction to facilitate its distribution; and the value of said information is increased by using said information for operation in said market for better returns.

### FIELD OF THE INVENTION

The present invention relates to a method of establishing a system of a secondary market for disbursement information, wherein purchase plan information about merchandise that nations, businesses or individuals possess is controlled and said disbursement information is provided to businesses or individuals who need said purchase plan information.

### BACKGROUND OF THE INVENTION

Conventionally each of nations, businesses and individuals has its information about expenditure which amount is equivalent to revenue, information about disbursement which amount is equivalent to sales as shown in its statement of accounts or information about spending which amount is equivalent to annual income.

Each of said information about expenditure can be regarded as information about a possible decision over future procurement, in other words, purchase plan information when viewed from its business counterpart.

For example, when a nation, firm or individual requires a vehicle for commercial activities, that firm will order a vehicle from a car dealer. The firm will pay money for the vehicle and will take delivery of the vehicle from the car dealer. This case also applies to the case of an individual.

Or, a third party used to introduce information of a certain firm about its expected procurement of a vehicle to a car dealer, and in return the car dealer used to give a candy box to the third party or used to entertain at a certain restaurant and the like as an introduction fee. Also, the car dealer used to put an advertisement by paying a large amount of money as an advertisement fee to the mass media such as TV or newspaper companies to promote sale of its cars and also, the dealer used to pay its salespersons a commission as incentives for sales promotion.

In other words, said firm used to pay the car dealer for the vehicle procured for commercial activities, whereas the car dealer used to pay a lot of various advertisement agencies a large amount of advertisement fees for sales of its cars.

In other words, both the firm and the car dealer used to perform extremely uneconomical business operation.

### SUMMARY OF THE INVENTION

The present invention provides a method of establishing a system of a secondary market for disbursement information, wherein conventional simple economic activities are eliminated, and by providing “purchase plan information” of merchandise possessed by nations, businesses or individuals with an asset value and by controlling said information independently, businesses and individuals who want to utilize the “purchase plan information” are given said information as information having an asset value and thus as chargeable.

In the claim 1 of the present invention, it is stated that there is information available about expenditure of a nation equivalent to its revenue, about disbursement of a business equivalent to its sales as shown in its statement of accounts, and about annual spending of an individual equivalent to its annual income. Said disbursement information can be called as information about a possible decision over future purchase or purchase plan information.

The present invention is characterized in that said purchase plan information is quantified; its value is computed by fixing a common currency unit such as yen; said information is swapped to bonds or warrants, or swapped to securities; said information is sold, bought or brokered by establishing a market for distribution of information or said information is brokered at auction under appropriate conditions of the auction to facilitate its distribution; and the value of said information is increased by using said information for operation in said market for better returns.

The present invention of claim 2 is characterized in that each disbursement information or purchase plan information is quantified; its value is computed by fixing a common currency unit such as yen; said information is swapped to bonds, warrants or securities; said information is sold, purchased or brokered online through internet or said information is sold, bought, or brokered at auction under appropriate conditions of the auction to facilitate its distribution; and the value of said information is increased by using said information for operation in said market for better returns.

The present invention of claim 3 is characterized in that said each disbursement information or purchase plan information is quantified; its value is computed by fixing a common currency unit like yen; said information is swapped to bonds or warrants, or swapped to securities; said information is entrusted with information distribution systems, and sold, bought, brokered or used for operation through said system; said information bears interest; a bidder at auction who made a successful bid on said information under appropriate conditions of the auction is liable for payment; and the value of said information is increased by using said information for operation in said market for better returns.

### BRIEF DESCRIPTION OF THE DRAWINGS

FIG. 1 is a disbursement flow diagram

FIG. 2 shows that sales are equal to disbursement.

FIG. 3 shows that disbursement information is equal to purchase plan information.

No description is given to symbols.

### DESCRIPTION OF THE PREFERRED EMBODIMENT

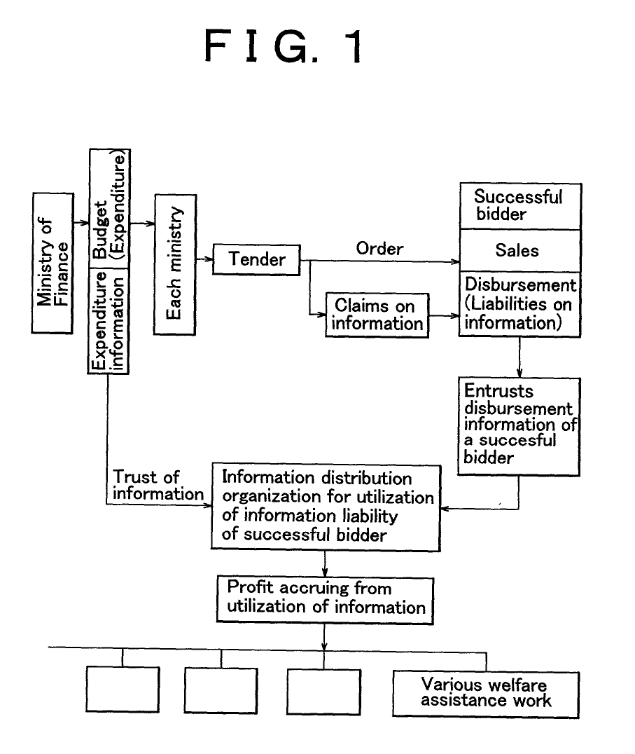

FIG. 1 shows an example relating to the present invention of a method of establishing a system of a secondary market for disbursement information. The embodiment is used to provide an explanation about a case wherein disbursement information of a nation and a successful bidder company is entrusted with said secondary market for information and used for operation in said market for better returns.

For example, in the case that a nation intends to purchase vehicles in one lump sum for use at administration agencies of its government, the government calls a tender for the purchase and invites related firms for the tender, and at the same time its expenditure information is entrusted with the secondary market for information. The figure illustrates that the successful bidder entrusts its disbursement information with the secondary market for information.

In the application of the present invention,

An information stockholder is defined as the owner of purchase plan information, having the intention to increase its value and to utilize it by saving, investing or entrusting of the information.

Utilization of information is defined as utilization of purchase plan information for returns.

Saving of information is defined as depositing of purchase plan Information at operating organizations for the purpose of saving.

Interest of information is defined as the interest accrued from utilization of “purchase plan information” that is deposited at information saving.

Information investment is defined as investment of purchase plan Information invested at operating organizations for purchase plan information for the purpose of investment.

Information trust is defined as trusting of purchase plan information with operating organizations for purchase plan information.

Information dividends are defined as dividends on purchase plan information invested or entrusted, payable to information stockholders.

Information claims are defined as related to utilization of purchase plan information.

Information liabilities are defined as related to utilization of purchase plan information.

Information securities are defined as a certificate representing a right to purchase plan information, such as information claims or information liabilities.

Information certificates are defined as related to utilization of purchase plan information.

Information certificates are defined as related to utilization of purchase plan information.

Information exchange is defined as utilization of purchase plan information with overseas.

Information management is defined in such a way that needs, the major factor of economic activities, are interpreted as “purchase plan information” and thereby the existence of needs is perceived as the main factor of economic activities by making qualitative and quantitative approach so as to handle and utilize theoretically.

Information distribution is defined in such a way that needs are perceived as the main economic activities, and their existence is treated qualitatively, while it is quantified by fixing its unit so as to be distributed like currencies.

Since the largest enterprise is a nation both worldwide and nationwide, most of the business related to the expenditure of a nation can be assigned to the information distribution system. The expenditure of a nation, therefore, is handled through utilization of information, and a large quantity of “purchase plan information” corresponding to the expenditure will flow into the information distribution organization from bidder companies with secondary profits resulted. FIG. 1 “Utilization of expenditure flow” illustrates the above flow. Namely, the Ministry of Finance entrusts the “purchase plan information” corresponding to the expenditure as information claims with the “information distribution organization for utilization of information liabilities of successful bidder companies”. The budget allocated to each ministry is used through tenders, and a successful bidder company will be liable for information liability in accordance with the bid amount. The successful bidder company entrusts its own “purchase plan information” (disbursement information) with the information distribution organization, which corresponds to information liabilities in accordance with the bid amount.

The expenditure paid by the government is entrusted with the information distribution organization in the form of the “purchase plan information” (disbursement information) of the successful bidder company.

Therefore, the expenditure paid by the government is collected in the form of “purchase plan information” of the successful bidder company, and the information itself begins to have a monetary value by utilizing it at the information distribution organization, and thus it is sold or purchased independently without any involvement in other factors.

A business firm with its turnover of 10 billion yen has disbursement information or purchase plan information in the amount of 10 billion yen. This is resources of disbursement information and it represents information resources available for utilization though it is disbursement information assets. Also, an individual having an annual income of five million yen has purchase plan information or disbursement information assets in the amount of five million yen per year. Its contents include house rent, electric charges, gas charges, communication fees, commuting expenses, insurance premiums, travel expenses, food expenses, reimbursement of various loan, saving, taxes and others, and all of them is paid from the annual income of five million yen.

Although it seems that electric charges are necessary expenses to an individual without having recognition of disbursement information as well as utilization consciousness, and there is no room for choice of payees, and it is not possible for the individual to utilize the disbursement of the charges as information resources for better returns, electric charges paid by individuals are valuable “purchase plan information” to both electricity and gas companies as observed in the scene where electricity companies are competing with gas companies fiercely as to supply of generated electricity that is used for power source of refrigerators, air-conditioning units and others. As regards communication fees, Nippon Telecommunications and Telephone Company used to control the demand for communications with an exclusive privilege under the protection of Electricity and Communications Law until recently, however, said law has been amended and free competition has been introduced under the pressure of advanced countries. Presently the company is granted as a communications enterprise capable of providing its own communications network. More than eight companies classified as a first-rated communications enterprise are competing each other fiercely seeking a larger share of the market.

Thus, electricity charges as well as communications charges of individuals are valuable “purchase plan information” to production enterprises. All of other disbursement such as insurance premiums, travelling expenses, wedding and funeral expenses, savings, taxes and others is “purchase plan information”, and therefore said disbursement is information that is directly related to their sales for business firms.

Although said “purchase plan information” is directly related to their sales for business firms, the present economic system has neither concept or organization to positively recognize and receive said “purchase plan information” for increase in its value and its utilization. For example, while someone is expecting to purchase a car that costs him/her two million yen, car manufacturers spend an enormous amount of money for their advertisement to look for purchasing people or customers. However, there is none of the economic systems to all to deposit and utilize the “purchase plan information” of said potential purchasing people.

If you visit the counter of a bank or post office, the clerks there are will willing to accept your saving money, whereas if you come to the counter of a bank or post office with “purchase plan information” that is two thousand times worth the above saving money and ask to utilize for better returns, the present system does not allow the bank or post office to accept this type of request to use for operation for better returns.

Since the main object of economic activities has been directed to pursuit of profits only, the concept of management of information about needs that is the main inducement of production has not been recognized at all.

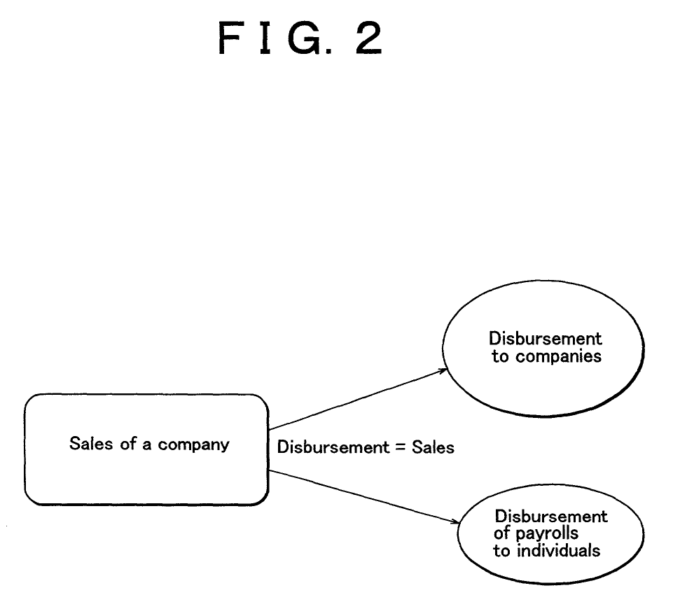

As illustrated in FIG. 2, sales by enterprises consist of disbursement of other firms or individuals.

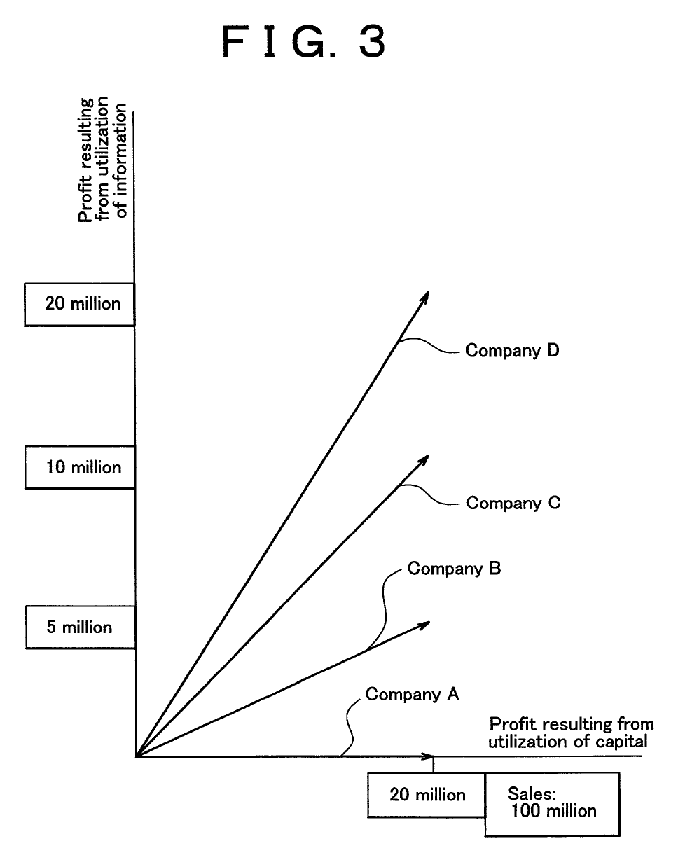

For example, as illustrated in FIG. 3, let's assume that there are four companies A, B, C and D, each having sales of 100 million yen and a profit of 20 million yen according to each statement of accounts. Company A does not utilize “purchase plan information” or disbursement information assets at all, whereas company B utilizes “purchase plan information” resulting in a profit of nine million yen accruing; company C utilizes “purchase plan information” resulting in a profit of ten million yen accruing; company D utilizes “purchase plan information” resulting in a profit of twenty million yen accruing.

Namely,

Company A's profit: 20 million

Company B's profit: 20 million+5 million=25 million

Company C's profit: 20 million+10 million=30 million

Company D's profit: 20 million+20 million =40 million

Based only on the evaluation of the statement of accounts of each company, each company A, B, C or D records sales of 100 million and a profit of 20 million, whereas a differential in actual profit between company A and company B reaches as high as two times due to utilization of the disbursement information.

A large amount of profit accrues at enterprises who know about disbursement information assets (purchase plan information) equivalent to sales by managing said assets properly.

With the abscissa (X-axis) representing profits accruing from sales and the ordinate (Y-axis) representing profits accruing from disbursement information assets, various characteristic curves on the coordinate provide useful data in that management capabilities of enterprises can be evaluated precisely.

The method of establishing a system of a secondary market for disbursement information of the present invention provides excellent effects in that disbursement information or purchase plan information is quantified; said information is swapped to bonds or warrants, or swapped to securities; said information is entrusted with information distribution systems wherein said information is sold, purchased, brokered, or bears interest; a bidder at auction who made a successful bid on said information is liable for disbursement; and thereby a secondary market or cyber market for disbursement can be established, wherein distribution of said information is promoted with its value increased and said information is utilized for operation at said market for better returns.

The method of establishing a system of a secondary market for disbursement information of the present invention provides excellent effects in that said information itself begins to have a monetary value by utilizing it at the information distribution organization, and thus it is sold or purchased independently without any involvement in other factors.

What is claimed is:

1. While there is information available about expenditure of a nation equivalent to its revenue, about disbursement of businesses equivalent to their sales as shown in their statement of accounts, and about annual spending of an individual equivalent to its annual income, a method of establishing a system of a secondary market for disbursement information characterized in that said information about national expenditure and other various spending represents information about expected purchase or purchase plan information; said purchase plan information is quantified; its value is computed by fixing a common currency unit like yen; said information is swapped to bonds or warrants, or swapped to securities; said information is sold, bought or brokered at a secondary market provided for information; said information is brokered at auction under appropriate conditions of the auction to facilitate its distribution; and the value of said information is increased by using said information for operation in said market for better returns.

2. While there is information available about expenditure of a nation equivalent to its revenue, about disbursement of businesses equivalent to their sales as shown in their statement of accounts, and about annual spending of an individual equivalent to its annual income, a method of establishing a system of a secondary market for disbursement information characterized in that said information about national expenditure and other various spending represents information about expected purchase or purchase plan information; said purchase plan information is quantified; its value is computed by fixing a common currency unit like yen; said information is swapped to bonds or warrants, or swapped to securities and sold, bought or brokered online through internet; said information is sold, bought, or brokered at auction under appropriate conditions of the auction to facilitate its distribution; and the value of said information is increased by using said information for operation in said market for better returns.

3. While there is information available about expenditure of a nation equivalent to its revenue, about disbursement of businesses equivalent to their sales as shown in their statement of accounts, and about annual spending of an individual equivalent to its annual income, a method of establishing a system of a secondary market for disbursement information characterized in that said information about national expenditure and other various spending represents information about expected purchase or purchase plan information; said purchase plan information is quantified; its value is computed by fixing a common currency unit like yen; said information is swapped to bonds or warrants, or swapped to securities; said information is entrusted with information distribution systems, and sold, bought, brokered or used for operation through said system; said information bears interest; a bidder at auction who made a successful bid on said information under appropriate conditions of the auction is liable for payment; and the value of said information is increased by using said information for operation in said market for better returns.
